(19) United States
(12) Patent Application Publication
(10) Pub. No.: US 2013/0324615 A1
(43) Pub. Date: Dec. 5, 2013

(54) BIODEGREDATION SUPPRESSION SOLUTION FOR FORENSIC SAMPLES

(71) Applicant: John Goodpaster, Indianapolis, IN (US)

(72) Inventor: John Goodpaster, Indianapolis, IN (US)

(73) Assignee: Indiana University Research and Technology Corporation, Indianapolis, IN (US)

(21) Appl. No.: 14/000,232

(22) PCT Filed: Feb. 23, 2012
(86) PCT No.: PCT/US2012/026286

§ 371 Date: Aug. 19, 2013

Related U.S. Application Data
(60) Provisional application No. 61/445,708, filed on Feb. 23, 2011.

(51) Int. Cl. G01N 1/28

(52) U.S. Cl. CPC G01N 1/28
USPC 514/721

(57) ABSTRACT

A biodegradation suppression system may include an anti-microbial agent, wherein the anti-microbial agent is effective to suppress biodegradation of ignitable liquid residues within a forensic sample. The biodegradation suppression system for use with a forensic sample may also include a solution including triclosan, wherein the solution suppresses biodegradation of ignitable liquid residues within a forensic sample for a period of time. The biodegradation suppression system for use with a forensic sample may also include a solution including triclosan, wherein the solution suppresses biodegradation of gasoline, wherein the solution is effective to allow for identification of at least one component of gasoline within the forensic sample.

### CROSS-REFERENCE TO RELATED APPLICATIONS

This application is a U.S. National Phase Patent Application of International Application Serial Number PCT/US2012/026286, filed Feb. 23, 2012, which is incorporated herein in its entirety, and which claims priority from U.S. Provisional Patent Application Ser. No. 61/445,708, filed Feb. 23, 2011, which is also incorporated herein in its entirety.

### GOVERNMENT LICENSE RIGHTS

This invention was made with government support under Grant No. 2010-DN-BX-K036 awarded by the National Institute of Justice. The United States Government has certain rights in the invention.

### FIELD

The present disclosure relates generally to biodegradation suppression, and more specifically, to a solution that suppresses biodegradation of ignitable liquid residues that may be present in forensic samples.

### BACKGROUND

Ignitable liquids, such as gasoline, are a common way to accelerate an incendiary fire. As a result, ignitable liquid residues (ILRs) are often found at or near the point of origin of a fire. ILRs are often partially to severely burned, although it is not unusual to encounter unburned samples. Forensic samples are often taken of fire debris in order to identify any ILRs and thereby determine the cause of a fire. Fire debris samples often include soil, decomposing wood and other organic matter.

Complicating matters is the complex nature of a fire debris sample, which consists of an extensive suite of organic and inorganic compounds including the matrix, pyrolysis products, combustion products and unburned fuel. In most cases, biological decomposition of a hydrocarbon molecule is carried out by communities of microbial species rather than one or a few species. This is because most media are already enriched with stable and complex microbial communities which have become adapted to the physical and chemical milieu specific to a site. The degradation caused by microbial communities is also more efficient because different 15 populations of organisms within a community will survive under different conditions (i.e., dry vs. wet, cool vs. warm soils, etc.). Finally, no single group will be capable of acting upon all hydrocarbon compounds in an ILR; a range of organisms, and hence a range of physiological processes, are responsible for hydrocarbon decomposition.

Unfortunately, the typical turnaround time for forensic analysis of a fire debris sample is more than sufficient for significant and irreversible microbial decomposition of hydrocarbon compounds in an ILR to occur. For example, Kirkbride et al. reported that fire debris samples presented to their laboratory might spend a period of between one and three weeks (seven to twenty one days) in storage before analysis (Kirkbride, K. P. et al., “Microbial Degradation of Petroleum Hydrocarbons: Implications for Arson Residue Analysis,” Journal of Forensic Sciences, JFSCA, Vol. 37, No. 6, November 1992, pp. 1585-1599, p. 1585). This period of time does not include the time between the fire and the collection of samples or the amount of time to transport the samples from the scene to the laboratory.

The detrimental effect of microbial action on the identification of ILRs in forensic samples that contain soil, decomposing wood or other organic matter is a well-known phenomenon in fire analysis. Mann et al. reported that analysis of some soil samples has resulted in the detection of a volatile mixture that lacks some (and, in some cases, most) of the diagnostic features associated with common petroleum products (Mann, D. C., et al, “Microbial Degradation of Gasoline in Soil,” Journal of Forensic Sciences, JFSCA, Vol. 35, No. 4, July 1990, pp. 913-923). The rate of microbial consumption of crude oil has been demonstrated to be dependent on the species of bacteria present, the temperature, and the nutrient concentration (Mann, D. C., et al, “Microbial Degradation of Gasoline in Soil,” Journal of Forensic Sciences, JFSCA, Vol. 35, No. 4, July 1990, pp. 913-923).

Microbial degradation in fire debris was first studied by Mann & Gresham of the Washington State Highway Patrol Crime Laboratory. Using garden soil spiked with gasoline, Mann & Gresham demonstrated that degradation occurred rapidly unless when the soil was thoroughly sterilized prior to introduction of gasoline or the gasoline/soil samples were stored at −5° C. For unsterilized samples stored at room temperature, the degradation process was characterized by a loss of substituted benzenes and all n-paraffinic compounds within days (Mann, D. C., et al, “Microbial Degradation of Gasoline in Soil,” Journal of Forensic Sciences, JFSCA, Vol. 35, No. 4, July 1990, pp. 913. (“This degradation . . . occurred in samples less than a week old . . . ”)). As a result of these findings, the authors stated that all soil samples submitted to their laboratory would henceforth be stored in a freezer until analysis is completed.

There are several practical considerations with adapting the methods discussed above to a forensic laboratory. For example, although immediately freezing samples has been suggested, samples are typically neither collected by laboratory personnel nor delivered promptly for proper storage. In addition, laboratories in general do not currently possess the resources or adequate space to maintain samples at low temperature.

Forensic scientists are concerned with the classes of hydrocarbon compounds that are found in ILRs, such as aliphatic hydrocarbons, cyclic alkanes, alkylbenzenes, polynuclear aromatics and indanes. Forensic researchers have found that microbial species metabolize different classes of hydrocarbon compounds used in the identification of ILRs (Chalmers, D. “Degradation of Gasoline, Barbecue Starter Fluid, and Diesel Fuel by Microbial Action in Soil,” Can. Soc. Forensic. Sci, J., Vol. 34, No. 2, 2001, pp. 49-62. Specifically, page 50 states “Kirkbride et al. (2) have shown 2 groups of Pseudomonas species to metabolize components of petroleum-based products. One of these groups, P. fluorescens biovar III, was shown to metabolize only aliphatic components, while the other, P. putida, was shown to metabolize only aromatic components (2).”) If allowed to progress unchecked, microbial degradation can eliminate the vast majority of compounds that constitute identification of an ILR and ultimately lead to inconclusive or even false negative findings in forensic cases (See Kirkbride, K. P. et al, “Microbial Degradation of Petroleum Hydrocarbons: Implications for Arson Residue Analysis,” Journal of Forensic Sciences, JFSCA, Vol. 37, No. 6, November 1992, p. 1585 (“FIG. 1 is a gas-liquid chromatogram of such a ILR mixture; as can be seen there are many similarities between this chromatogram and that of authentic gasoline (FIG. 2) but the absence of key substances such as benzene, toluene or hexane made conclusive identification for forensic purposes difficult.”)).

Chalmers et al. repeated the work by Mann & Gresham using GC/MS technology as well as evaluating the effect of microbes on gasoline, a medium petroleum distillate (MPD) and a heavy petroleum distillate (HPD). Both rural and garden soils were used as substrates and significant degradation of n-alkanes and mono-substituted aromatics was noted in all samples after 7-14 days.

Chalmers et al. stated that automotive gasoline exhibited very slight degradation through seven (7) day trials, but experienced extensive degradation after fourteen (14) days. Barbecue starter fluids showed little degradation up to seven (7) days, followed by extensive degradation between seven (7) and fourteen (14) days in soil. Diesel fuel showed slight degradation after 10 seven (7) days and extensive degradation after fourteen (14) days in soil.

Chalmers et al. also reported that N-alkanes and mono-substituted aromatics were more thoroughly degraded before substituted aliphatic or poly-substituted aromatic compounds in all trials. Indicative of the microbial degradation problem, Chalmers et al. added that extensive degradation occurring between the seven (7) and fourteen (14) day trials made it unclear as to 15 which compounds were being more readily degraded between seven (7) and fourteen (14) days.

Kirkbride et al. isolated two species of bacteria (Pseudomonas putida and Pseudomonas biovar III) from fire debris samples that had generated an anomalous chromatographic pattern (Kirkbride, K. P. et al, “Microbial Degradation of Petroleum Hydrocarbons: Implications for Arson Residue Analysis,” Journal of Forensic Sciences, JFSCA, Vol. 37, No. 6, November 1992, p. 1585. (“In a small but significant number of cases unusual mixtures of hydrocarbons are detected.”). The ability of these bacteria to degrade gasoline and petroleum naphtha was evaluated in vitro and the two species were found to be complementary in their action, in that P. putida decomposed aromatic portions of the fuels while P. fluorescens biovar III decomposed the aliphatic portion. Kirkbride et al. offered recommendations for avoiding microbial degradation such as storing samples at reduced temperature as suggested by Mann & Gresham. Kirkbride et al. also hypothetically proposed adding a non-volatile bactericide to the fire debris. Alternatively, if microbial degradation is detected, the authors recommended demonstrating the presence of bacteria by culturing the fire debris samples and screening for species that are known to degrade petroleum and generate anomalous chromatographic profiles.

Cherry et al. analyzed gasoline, a MPD and an HPD on three different types of soil using a dynamic heated headspace technique and gas chromatography. Significant degradation in the samples was not detected until after two weeks. Degradation was prominent in the soil that was darker (i.e., more enriched in organic matter) and more moist than the other two soil types. It was determined that microbial degradation occurred among the n-alkanes in both of the petroleum distillates. Microbial degradation occurred among the aromatics in gasoline, but to a lesser extent than the degradation of the n-alkanes in the petroleum distillates.

### SUMMARY

The present disclosure generally relates to biodegradation suppression of forensic samples by use of an anti-microbial agent. The anti-microbial agent solution is effective to suppress biodegradation of ILRs for a period of time. The anti-microbial agent solution is effective to allow for identification of ILRs within forensic samples by biodegradation suppression.

In one aspect, the present disclosure is directed to an ignitable liquid residue biodegradation suppression system. The system comprises: a base; and an antimicrobial agent, wherein the anti-microbial agent is at a concentration effective to suppress biodegradation of an ignitable liquid residue within a forensic sample for a period of time.

In another aspect, the present disclosure is directed to an ignitable liquid residue biodegradation suppression system for use with a forensic sample comprising an aqueous solution including triclosan or a derivative thereof The solution suppresses biodegradation of an ignitable liquid residue within the forensic sample for a period of time.

In another aspect, the present disclosure is directed to a method of suppressing biodegradation of an ignitable liquid residue. The method comprises the steps of: contacting a forensic sample having or suspected of having the ignitable liquid residue with an amount of an anti-microbial agent effective to suppress biodegradation of the ignitable liquid residue within the forensic sample, wherein biodegradation is suppressed for a period of time.

### BRIEF DESCRIPTION OF THE DRAWINGS

The above-mentioned and other features of this disclosure, and the manner of attaining them, will become more apparent and the disclosure itself will be better understood by reference to the following description of embodiments of the disclosure taken in conjunction with the accompanying drawings, wherein:

FIG. 1 describes a growth curve constructed using UV-vis analysis of cultures taken from soil exposed to water, 0.1 M sodium hydroxide (NaOH), 1.81% triclosan and bleach.

FIG. 2 illustrates the biodegradation of ignitable liquid in a soil sample with water.

FIG. 3 illustrates the biodegradation of ignitable liquid in a soil sample with 0.1 M NaOH.

FIG. 4 illustrates the biodegradation suppression of ignitable liquid in a soil sample with 1.81% triclosan in 0.1 M NaOH.

FIG. 5 illustrates (A) biodegradation of gasoline and preservation of gasoline by (B) bleach and by (C) 2% Triclosan in 0.2 M NaOH after the following periods of time: (a) 0 days, (b) 2 days, (c) 7 days, (d) 11 days, (e) 15 days, (f) 22 days, and (g) 30 days by displaying a region of Total Ion Current (TIC) chromatograms where a group of five compounds elute.

FIG. 6 illustrates (A) biodegradation of gasoline and preservation of gasoline by (B) 2% Triclosan in 0.2 M NaOH after the following periods of time: (a) 0 days, (b) 28 days, and (c) 140 days by displaying Total Ion Current (TIC) chromatograms.

Corresponding reference characters indicate corresponding parts throughout the several 30 views. Although the drawings represent embodiments of the present disclosure, the drawings are not necessarily to scale and certain features may be exaggerated in order to better illustrate and explain the present disclosure.

### DETAILED DESCRIPTION OF THE EXEMPLARY EMBODIMENTS

The embodiments disclosed below are not intended to be exhaustive or limit the disclosure to the precise forms disclosed in the following detailed description. Rather, the embodiments are chosen and described so that others skilled in the art may utilize their teachings.

The purpose of this research is to create an antimicrobial solution that will prevent the biodegradation of ignitable liquid residues so that forensic scientists can accurately identify ignitable liquid residues in arson cases.

The following criteria is established for a successful forensic sample preservative: (1) can be safely and immediately deployed by an on-scene investigator at the time of evidence collection; (2) can suppress or eliminate the activity of microbes responsible for degradation of ignitable liquids in soil for periods of at least 120 days; and (3) does not degrade ignitable liquids, damage evidence containers, or interfere with standard methods for ignitable liquid concentration and identification.

Soil Samples

In addition to a commercially-available potting soil, additional soil samples were gathered around Muncie, Indiana four times over the course of one year. Three types of soil samples were gathered: agricultural, industrial, and residential. The soil types have been identified as follows: Agricultural: Pella silty clay loam, PgaA; Industrial: Urban land/Wawaka-Miami Complex; and Residential: Miamian loam MoeB2.

Soil material of the same soil type was composited, air-dried, ground with a mortar and pestle and passed through a 2-mm mesh sieve prior to analysis.

Populations of total bacteria, fungi and actinomycetes were assayed in the soil samples. Genetic analysis was also completed to identify specific species of bacteria that were present. Characterization of bacterial populations was carried out on all soil samples.

Anti-Microbial Agent Screening

In anti-microbial agent screening studies, a soil sample was extracted with a 0.9% saline solution of sodium chloride (NaCl) and water (H₂O) and a sample loop was used to transfer approximately 10 μL of extract to a test tube containing sterile Tryptic Soy Broth (TSB). The broth samples were allowed to stand for 24 hours, during which time a visible population of bacteria grew. The broth samples were then treated with anti-microbial agents at a known concentration. The treated broth samples were then sub-cultured in another sterile TSB, minimal media (MM) or spread on sterile Tryptic Soy Agar (TSA) plates. MM is a nutrient deficient growth medium where citric acid is the only carbon source and which is selective against many species of bacteria. Bacterial growth was confirmed by visible inspection of the secondary TSB, MM or TSA plate. The broth/plate samples were then evaluated for how long they remained free of bacterial growth. Table 1 illustrates the performance of several anti-microbial agents using this procedure. The column labeled Bacterial Confirmatory Analysis provides the subculture media used to confirm bacterial growth.

TABLE 1

| | Bacterial | | |
|---|---|---|---|
| | Confirmatory | | Effective |
| Chemical | Analysis | Effective [ ] | Period |
| Bleach in water | MM and TSB | 12% | n/a |
| NaN₃ in water | MM and TSB | 0.04M | n/a |
| Copper Sulfate in water | TSA plates | 5% | 0 days |
| Betadine in water | TSA plates | 20% | 0 days |
| Chlorhexidine in water | TSA plates | 14% | 0 days |
| Triclosan in MeOH | TSA plates | 0.50% | 7 days |
| Triclosan in MeOH | TSA plates | 1% | 14 days |
| Triclosan in Glycerin | TSA plates | 0.50% | 7 days |
| Triclosan, benzalkonium chloride, | TSA plates | 1 g each in 5% | 2 days |
| benzethonium chloride | | glycerin/water | |
| Benzalkonium chloride in water | TSA plates | 1% | 0 days |
| Benzethonium chloride in water | TSA plates | 1% | 0 days |

Cultures from treatment with bleach and sodium azide (NaN₃) did not show growth after 24 hours and were not monitored beyond this time.

Based upon preliminary results for triclosan in methanol, a higher concentration of triclosan was sought and eventually attained by dissolving the compound in a basic medium (i.e., 0.1 M-0.2 M NaOH) at a concentration of approximately 2% w/v.

Additional culturing studies were carried out where a soil sample was directly treated with an anti-microbial agent. The exposure time of the soil sample to the anti-microbial was either 60 seconds or 24 hours. The extract was then sampled and used to inoculate a sterile TSB. The amount of time for bacterial growth to become visible was then noted. Table 2 illustrates the performance of several anti-microbial agents using this procedure.

TABLE 2

| | Effective | Exposure | Effective |
|---|---|---|---|
| Chemical | [] | Time | period |
| Neo/Strepto/Poly | 10 mg/mL | 60 s | Cloudy after 72 hrs. |
| | 10 mg/mL | 24 hrs | Cloudy after 72 hrs. |
| Neo/Bac | 2 mg/mL | 24 hrs | Cloudy after 48 hrs. |
| | 10 mg/mL | 60 s | Cloudy after 48 hrs. |
| Neo/Pen | 10 mg/mL | 60 s | Cloudy after 48 hrs. |
| Strepto/Poly | 10 mg/mL | 60 s | Cloudy after 48 hrs. |
| Strepto/Neo | 10 mg/mL | 24 hrs | Cloudy after 48 hrs. |
| Strepto/Pen | 10 mg/mL | 24 hrs | Cloudy after 48 hrs. |
| Neo/Bac/Poly | 10 mg/mL | 60 s | Cloudy after 48 hrs. |
| Neo/Bac/Poly/Strepto/Pen | 10 mg/mL | 60 s | Cloudy after 72 hrs. |
| Chlorhexidine in water | | 60 s | Cloudy after 8 days |
| | | 24 hrs | Still clean after 36 days |
| Bleach | Pure | 60 s | Still clean after 36 days |
| | | 24 hrs | Still clean after 36 days |
| Silver colloid | Pure | 24 hrs | Cloudy after 8 days |

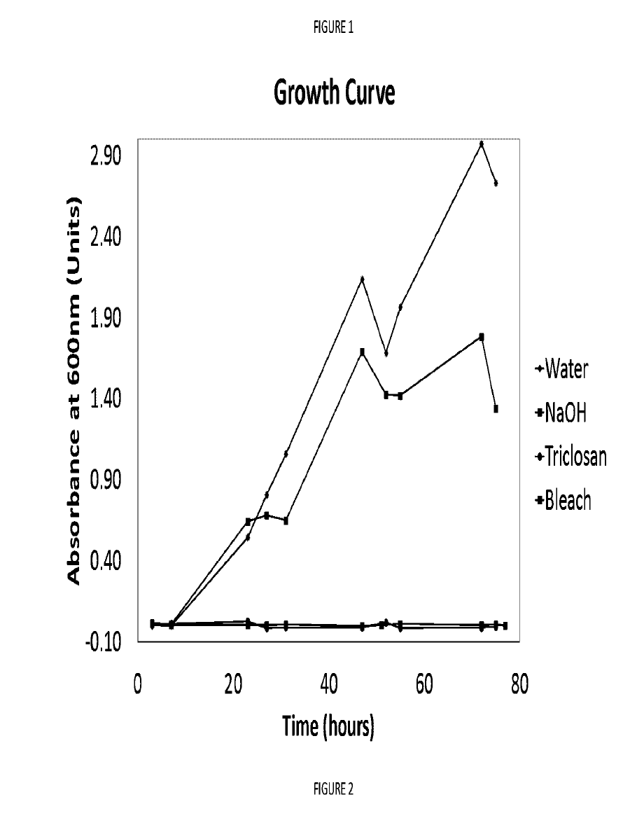

A final culturing study was conducted where a set of culture tubes containing sterile TSB were inoculated with a saline extract of a soil sample. One set of culture tubes contained only sterile TSB, a second set contained sterile TSB treated with 0.1 M NaOH, a third set contained sterile TSB treated with 1.8% triclosan in 0.1 M NaOH and a fourth set contained sterile TSB treated with bleach. The culture tubes were allowed to stand at room temperature for periods of up to 80 days. Growth was then monitored three times daily for up to 4 days by a single beam diode array UV-Vis Spectrophotometer in the 400 nm to 800 nm range. The absorbance of the samples at 600 nm was monitored over the course of the study. FIG. 1 illustrates that both triclosan and bleach were able to prevent bacterial growth whereas TSB that was either untreated or treated with NaOH exhibited significant bacterial growth as manifested by sample absorbance.

Overall, the in-lab culturing studies described above have shown that of the antimicrobial agents studied, bleach and triclosan were the most effective. Triclosan was then selected as a candidate for an effective forensic sample preservative as, unlike bleach, it did not promote corrosion of the sample containers nor did it introduce any side-products into the recovered ILR (see below). In-lab culturing studies have shown that the chemical triclosan is presently a candidate for an effective anti-microbial agent.

Biodegradation Studies

Preliminary Biodegradation Studies

In preliminary culturing studies, a passive headspace study was designed and conducted over a 30-day period, and the resulting samples were analyzed via GC/MS.

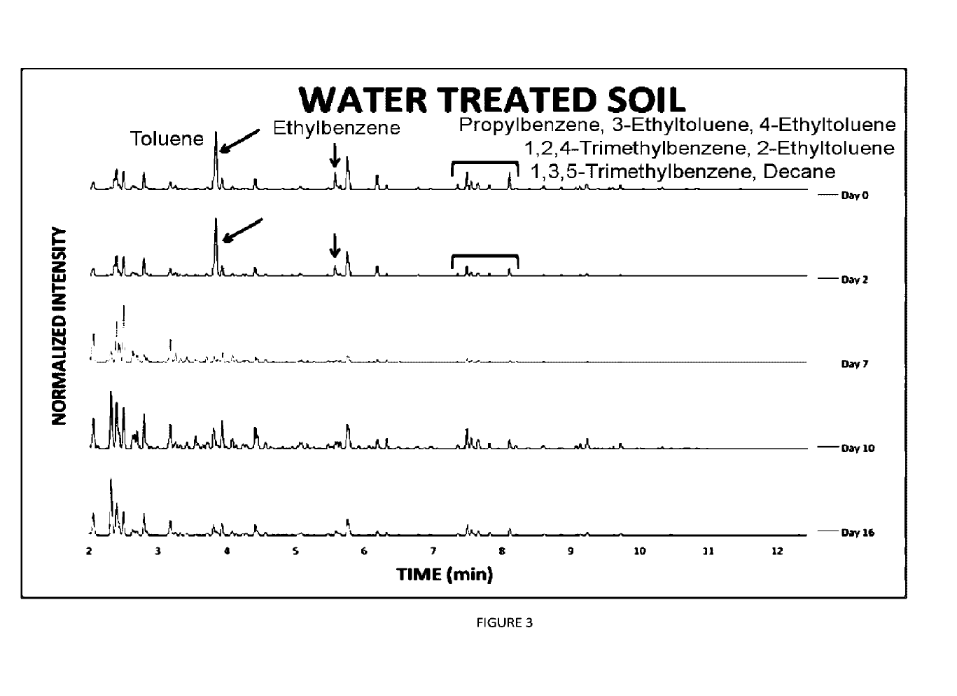

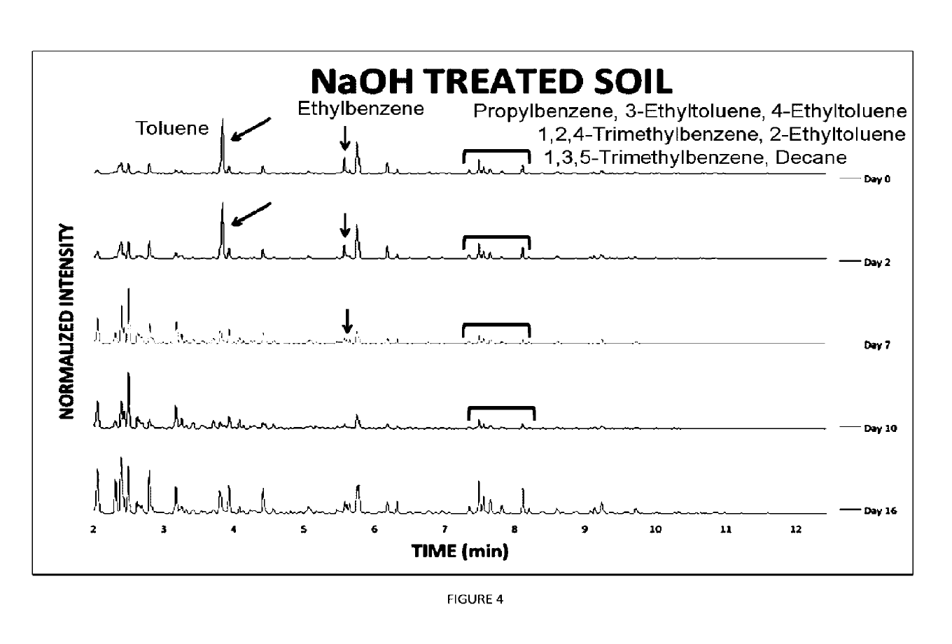

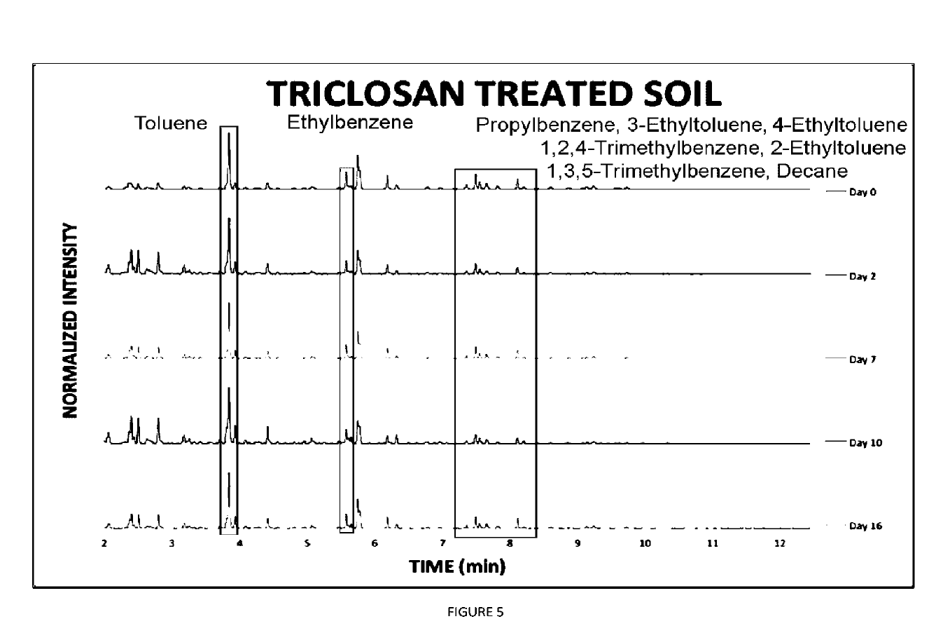

In these preliminary culturing studies three soil mixtures were prepared. Soil mixtures were stored in an airtight sealed quart-sized tin can for periods of up to 30 days. All soil mixtures received 20 μL of ignitable liquid (87 octane gasoline) spiked onto potting soil. The mass of potting soil was not crucial. Most measurements were within the range of approximately 60 grams and approximately 100 grams of potting soil. FIG. 2 soil mixtures received 70 mL of water. FIG. 3 soil mixtures received 70 mL of 0.1 M NaOH. FIG. 4 soil mixtures received 70 mL of approximately 1.81% triclosan in 0.1 M NaOH. The concentration of triclosan was not precise. Concentrations of triclosan were within the range of approximately 1% to approximately 2%. Treated soil samples were allowed to stand for periods of up to 30 days.

After the respective test period for each sample, each sample was then extracted using passive headspace adsorption onto a charcoal strip. Each sample was heated at 85° C. for 4 hours 20 and the strip eluted with 300 μL of pentane.

All extracts were analyzed using an Agilent GC/MS. The temperature program included an initial temperature of 40° C. held for 3 min., a ramp of 10° C./min, and a final temperature of 280° C. held for 3 min. Each component was identified based upon comparison of the retention time and mass spectrum to an authentic standard and the NIST mass spectral database.

Water-treated soil mixture results are illustrated in FIG. 2. NaOH treated soil mixture results are illustrated in FIG. 3. Triclosan soil mixture results are illustrated in FIG. 4. The arrows and brackets highlighting various places on the chromatogram indicate the peaks used in gasoline identification. These peaks include toluene (˜3.8 min); ethyl benzene (˜5.5 min); propylbenzene (˜7.2 min); and 3-ethyltoluene (˜7.3 min), 1,2,4-trimethylbenzene 30 (˜7.5 min), 2-ethyltoluene (˜7.6 min), 1,3,5-trimethyl benzene (˜7.8 min) and 4-ethyltoluene.

As illustrated in FIG. 2, the water-treated soil mixtures show that after seven (7) days, several components of gasoline have been severely degraded. As illustrated in FIG. 3, the NaOH-treated soil mixtures show that after seven (7) to sixteen (16) days, several components of gasoline have been severely degraded. As illustrated in FIG. 4, the triclosan-treated soil mixtures show that after sixteen (16) days, several components of gasoline are still identifiable. Several peaks are identifiable until day twenty-five (25). As evidenced by the preliminary culturing studies, triclosan in 0.1 M NaOH anti-microbial solution is effective in the preservation of gasoline in potting soil for at least twenty-five (25) days.

Subsequent Biodegradation Tests

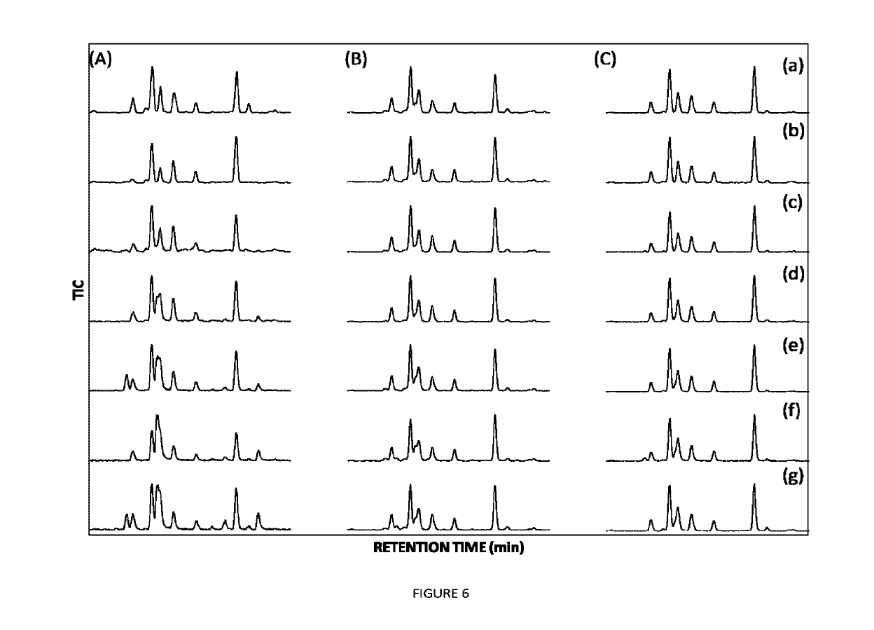

In subsequent testing, samples of potting soil spiked with gasoline were stored in airtight sealed quart-sized tin cans for periods of time. All soil samples were spiked with 20 μL 87 octane gasoline. The mass of potting soil was not crucial. Most measurements were within the range of approximately 60 grams and approximately 100 grams of potting soil. As illustrated in FIG. 5, Column A soil samples were left untreated. Column B soil samples received approximately 70 mL of bleach. Column C soil samples received approximately 70 mL of 2% triclosan in 0.2 M NaOH.

All soil samples were then allowed to stand for significant periods of time. After the test period for a given sample, it was then extracted using passive headspace adsorption onto a 15 charcoal strip. In this procedure, each sample was placed in an oven, heated at 85° C. for 4 hours and then allowed to cool to room temperature. The charcoal strip was then removed from the can, placed in a test tube and 300 μL of pentane. The sample was then vortexed for approximately one minute. The pentane extract was then transferred to a GC vial.

All extracts were analyzed using an Agilent GC/MS. One microliter of the extract was injected with a 20:1 split ratio. The GC inlet was held at 250° C. The carrier gas was helium, held at a constant flow rate of 1 mL/min. The GC oven temperature program included an initial temperature of 40° C. held for 3 min., a ramp of 10° C./min, and a final temperature of 280° C. held for 3 min. The mass spectrometer was operated in full scan mode between m/z 40 and m/z 300. The following components were identified based upon comparison of their retention times and mass spectrum to an authentic standard and the NIST mass spectral database: toluene, ethylbenzene, propylbenzene, o-,m- and p-xylene, 1,3,5-trimethylbenzene, 1,2,4-trimethylbenzene and all straight chain alkanes between heptane and eicosane (also known as icosane and dedecyl).

There are several proposed ways to identify degradation of ILR. As previously mentioned, forensic scientists are concerned with the classes of hydrocarbon compounds that are found in ILRs, such as aliphatic hydrocarbons, cyclic alkanes, alkylbenzenes, polynuclear aromatics and indanes. Chalmers and co-workers focused on significant degradation of straight chain alkanes and mono-substituted aromatics.

An ILR component was considered to be identified if the agreement between its retention time and that of the standard was less than 5%, the match score of the mass spectrum to the correct compound in the mass spectral database was at least 800 out of 1000 and that the mass spectrum was also indistinguishable from that of the standard. The extent of degradation was assessed by visual inspection of the total ion chromatogram and comparison to a sample that was prepared in soil but immediately analyzed so that it remained undegraded. In general, microbial degradation was recognized in samples by the selective loss of monosubstituted alkyl benzenes (i.e., toluene, ethylbenzene and propylbenzene) in addition to the loss of all straight chain alkanes.

The results for this study are shown in FIG. 5 which depicts a “group of five”, which is a region of the chromatogram where the following compounds elute: 2-, 3- and 4-ethyltoluene, 1,3,5-trimethyl benzene and 1,2,4-trimethylbenzene. It is also envisioned that triclosan is effective in the preservation and identification of straight chain alkanes. Identification techniques for degradation of straight chain alkanes between heptane and eicosane are also envisioned.

As illustrated in FIG. 5, column A soil samples show that after eleven (11) days, the chromatogram becomes distorted and several components of gasoline have been severely degraded. Column B soil samples show that the gasoline is largely preserved, although an additional side-product becomes apparent at long times, resulting in distortion of the chromatogram. Finally, column C soil samples show that even after thirty (30) days, the chromatogram is preserved and all components of gasoline are still identifiable. In conclusion, triclosan in NaOH anti-microbial solution is effective in the preservation of gasoline in lawn, residential, agricultural, industrial and potting soil for at least 30 days. It is further contemplated that triclosan in NaOH can preserve ILRs for at least 60 days, at least 90 days, and at least 120 days.

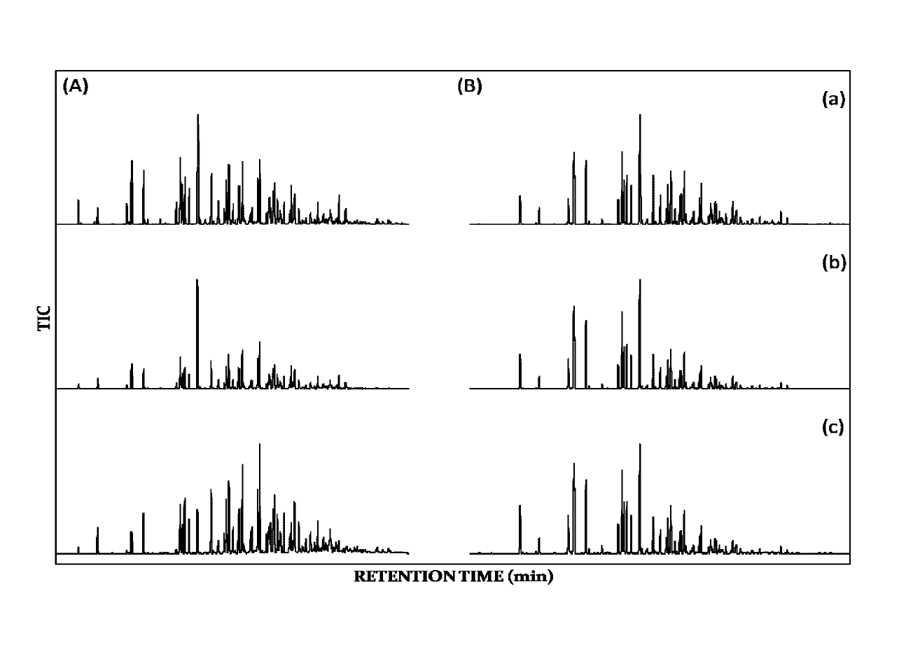

As illustrated in FIG. 6, an additional study was then repeated under alternative conditions whereby a Molotov cocktail containing gasoline was deployed on a patch of exposed lawn soil.

In this FIG. 6 study, a beer bottle was filled to the bottom of the neck with gasoline. A cloth was inserted into the bottle so that the gasoline wicked up the cloth. The wick was lit and the Molotov cocktail was broken over a brick onto a 3×3′ patch of lawn soil. Once the fire had self-extinguished the glass fragments were collected and then approximately 3 gallons of soil was collected and homogenized in a 5 gallon pail. The soil was split into forty-eight (48) cans, filling each can no more than half full. Twenty-four (24) cans of the forty-eight (48) cans remained untreated. The untreated column A soil samples were immediately sealed in airtight quart-sized tin cans. Twenty-four (24) were treated with the triclosan solution. Column B soil samples were treated with 2% w/v triclosan in 0.2 M NaOH prior to being sealed in a sample container.

The soil samples were then stored at room temperature for periods of up to 140 days. The cans were sealed and stored until the specified time point when the cans were opened and one-third of a carbon strip was suspended in each can. The cans were resealed and baked at 85° C. for 4 hr. Upon cooling, each strip was removed and the gasoline residue was extracted from the strip using 400 μL of pentane with vortexing for ˜1 min. The solution was then transferred to an autosampler vial and analyzed by GC-MS.

The results of this study are shown in FIG. 6, where column A soils exhibit significant distortion due to microbial degradation. In contrast, column B soils are extremely well preserved and exhibit no significant or identification altering degradation. In conclusion, triclosan in NaOH anti-microbial solution is effective in the preservation of ILRs in various soil types for extended periods of time.

The concentration of triclosan in all of these studies was approximately 2% (w/v). However, it is envisioned that the concentrations of triclosan could be higher or lower than the provided range. For example, it is contemplated that concentration of anti-microbial agent such as triclosan can be from approximately 0.1% to approximately 10%, from approximately 0.5% to 20 approximately 5%, from approximately 1% to approximately 4%, or from approximately 2% to approximately 3% (w/v). Alternatively, the concentration of anti-microbial agent can be approximately 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5% or 10% (w/v). As used herein “triclosan,” also known as 2,4,4′-trichloro-2′-hydroxydiphenyl ether, includes any triclosan and derivatives thereof that suppress biodegradation of ILRs. Examples of such triclosan derivatives include, but are not limited to, those disclosed in US Patent Application Publication Nos. 2010/0041658 and 2010/0092530; U.S. Pat. Nos. 5,968,207; 6,197,072; 6,299,651and8,053,591; as well as Int'l Patent Application No. PCT/GB 1995/001544.

Sodium hydroxide (NaOH) was used as a base in order to dissolve triclosan in solution. 30 It is envisioned that triclosan is effective over a range of pH values. The concentration of Na OH in these studies was approximately 0.2 M. However, it is contemplated that the concentrations of NaOH could be higher or lower than the provided range. For example, it is contemplated that concentration of base such as NaOH can be from approximately 0.01 M to approximately 0.5 M, from approximately 0.1 M to approximately 0.4 M, from approximately 0.2 M to approximately 0.3 M. Alternatively, the concentration of base can be approximately 0.01 M, 0.05 M, 0.1 M, 0.2 M, 0.3 M, 0.4 M or 0.5 M. As used here, “base” means a compound capable of accepting a proton, such as a base belonging to the hydroxide (OH) family. Any base should work for the same purpose. Examples of such bases include, but are not limited to, salts of alkali metals such as sodium, potassium, calcium, guanidinium, lithium, magnesium and the like. Other antimicrobial agents which do not require a basic environment can be effective as forensic sample preservatives. Previous testing has indicated similar mechanisms of microbial biodegradation for all ILRs. It is envisioned that anti-microbial agents, such as triclosan, would be effective for preservation of other ILRs, such as petroleum distillates, even though gasoline has been used as the ignitable liquid for almost all of the tests disclosed in this application. It is also envisioned that anti-microbial agents, such as triclosan, would be effective in a number of soil types and environments.

While the novel technology has been illustrated and described in detail in the figures and foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

1. An ignitable liquid residue biodegradation suppression system, the system comprising:
a base; and
an anti-microbial agent, wherein the anti-microbial agent is at a concentration effective to suppress biodegradation of an ignitable liquid residue within a forensic sample for a period of time.

2. The biodegradation suppression system of claim 1, further comprising an aqueous solution within which the base and the anti-microbial agent can be suspended.

3. The biodegradation suppression system of claim 2, wherein the base is at a base concentration within the range of approximately 0.01 M to approximately 0.5 M when suspended in the aqueous solution.

4. (canceled)

5. The biodegradation suppression system of claim 2, wherein the antimicrobial agent concentration is within the range of approximately 0.5% to approximately 5% (w/v) when suspended in the aqueous solution.

6. (canceled)

7. The biodegradation suppression system of claim 2, wherein the antimicrobial agent concentration is approximately 1.81% (w/v).

8. The biodegradation suppression system of claim 1, wherein the anti-microbial agent is triclosan or a derivative thereof.

9. The biodegradation suppression system of claim 1, wherein the base is sodium hydroxide.

10. The biodegradation suppression system of claim 1, wherein the ignitable liquid is gasoline.

11. An ignitable liquid residue biodegradation suppression system for use with a forensic sample comprising an aqueous solution including triclosan or a derivative thereof, wherein the solution suppresses biodegradation of an ignitable liquid residue within the forensic sample for a period of time.

12. The biodegradation suppression system of claim 11, wherein the period of time is at least twenty-one days.

13. The biodegradation suppression system of claim 11, wherein the solution suppresses biodegradation of aromatic portions of the ignitable liquid residue.

14. The biodegradation suppression system of claim 11, wherein the solution suppresses biodegradation of aliphatic portions of the ignitable liquid residue.

15. The biodegradation suppression system of claim 11, wherein the ignitable liquid residue is gasoline.

16. The biodegradation suppression system of claim 15, wherein the solution suppresses biodegradation of at least one component of gasoline selected from the group consisting of 2-ethyltoluene, 3-ethyltoluene, 4-ethyltoluene, 1,2,4-trimethylbenzene, and 1,3,5-trimethylbenzene.

17. A method of suppressing biodegradation of an ignitable liquid residue, the method comprising the steps of:
contacting a forensic sample having or suspected of having the ignitable liquid residue with an amount of an anti-microbial agent effective to suppress biodegradation of the ignitable liquid residue within the forensic sample, wherein biodegradation is suppressed for a period of time.

18. (canceled)

19. (canceled)

20. The method of claim 17, wherein the anti-microbial agent suppresses or eliminates the activity of microbes that degrade one or more of straight chain alkanes and mono-substituted aromatics.

21. (canceled)

22. The method of claim 17, wherein the period of time is at least twenty-one days.

23. The method of claim 17, wherein the anti-microbial agent is triclosan or a derivative thereof.

24. The method of claim 17 wherein the anti-microbial agent is provided in an aqueous solution.

25. The method of claim 24, wherein the aqueous solution is a basic solution.
